(19) United States
(12) Patent Application Publication
(10) Pub. No.: US 2009/0034107 A1
(43) Pub. Date: Feb. 5, 2009

(54) REDUNDANT DATA ON HARD DRIVE

(76) Inventor: Joshua Posamentier, Oakland, CA (US)

Correspondence Address: INTEL CORPORATION;c/o INTELLEVATE, LLC, P.O. BOX 52050, MINNEAPOLIS, MN, 55402, US

(21) Appl. No.: 11/833,999

(22) Filed: Aug. 5, 2007

(51) Int. Cl. G11B 5/86

(52) U.S. Cl. 360/15

(57) ABSTRACT

Duplicate copies of data may be stored in different sectors on the same track of a disk drive. When reading the data, the data may read from the sector that passes under the read head soonest, thus decreasing data access latency. In some embodiments, the duplicate sectors may be equally spaced around the track. In some embodiments, the spin rate of the disk drive may be reduced to save power, with the increased data latency that would normally be created by the reduced spin rate to be at least partially offset by the decreased data latency created by using multiple copies of the data in the different sectors

### BACKGROUND

Currently, hard disk drives consume much of their power just overcoming bearing friction while spinning. The faster the drive spins, the more power that is consumed but the lower the average data access latency as the targeted sector reaches the read head more quickly. Conversely, spinning the drive slower consumes less power but increases data access latency. System designers must make a tradeoff and decide which desirable quality to sacrifice—lower power consumption or faster data access.

### BRIEF DESCRIPTION OF THE DRAWINGS

Some embodiments of the invention may be understood by referring to the following description and accompanying drawings that are used to illustrate embodiments of the invention. In the drawings:

FIG. 1 shows a disk-based data storage system, according to an embodiment of the invention.

FIG. 2 shows a flow diagram of a method of reading and writing duplicate data in multiple sectors, according to an embodiment of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure an understanding of this description.

References to “one embodiment”, “an embodiment”, “example embodiment”, “various embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

In the following description and claims, the terms “coupled” and “connected,” along with their derivatives, may be used. It should be understood that these terms are not intended as synonyms for each other. Rather, in particular embodiments, “connected” is used to indicate that two or more elements are in direct physical or electrical contact with each other. “Coupled” is used to indicate that two or more elements co-operate or interact with each other, but they may or may not be in direct physical or electrical contact.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

Various embodiments of the invention may be implemented in one or any combination of hardware, firmware, and software. The invention may also be implemented as instructions contained in or on a machine-readable medium, which may be read and executed by one or more processors to enable performance of the operations described herein. A machine-readable medium may include any mechanism for storing, transmitting, and/or receiving information in a form readable by a machine (e.g., a computer). For example, a machine-readable medium may include a tangible storage medium, such as but not limited to read only memory (ROM); random access memory (RAM); magnetic disk storage media; optical storage media; a flash memory device, etc. A machine-readable medium may also include a propagated signal which has been modulated to encode the instructions, such as but not limited to electromagnetic, optical, or acoustical carrier wave signals.

In various embodiments of the invention, identical data may be stored in multiple sectors on the same track of a disk drive. When the data is to be read, whichever sector passes under the disk head first will be the sector that is read. In this manner, average access latency may be reduced by a factor of two or more. Alternately, the spin rate of the disk drive may be reduced to save power, but the duplicate sector may prevent the access latency time from increasing over that of a faster-spinning disk with non-duplicate sectors. In some embodiments, the duplicate sectors may be equally spaced around the track (e.g., on opposite sides for two redundant sectors, spaced approximately 120 degrees apart for three redundant sectors, etc.).

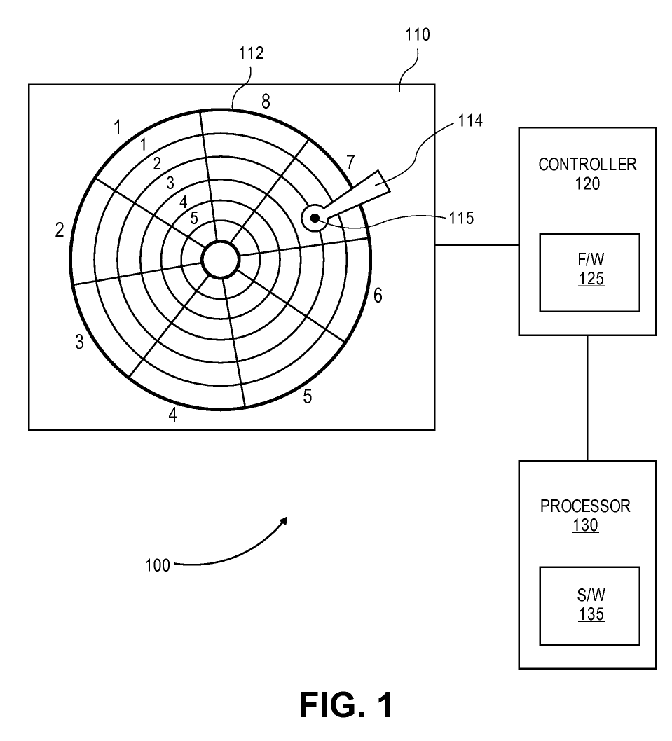

FIG. 1 shows a system, according to an embodiment of the invention. In the illustrated embodiment of FIG. 1, a system 100 includes a processor 130 coupled to a disk controller 120, which is in turn coupled to a disk drive 110. The specific example illustrated here shows the operations of the processor being controlled by software 135, and the operations of the disk controller being controlled by firmware 125, but other embodiments may use different techniques. For example, the disk controller 1) may be hardwired to perform its functions, 2) may be controlled by a state machine, 3) may have its operations controlled largely by the system processor, 4) may be controlled by the operating system at a driver or application layer, 5) may use a combination of these techniques, 6) etc.

A conceptual view of disk drive 110 shows a platter 112, a read/write head assembly 115 that reads and writes data into the magnetic surface of the platter 112, and a head positioning mechanism 114 that can move the head 115 to specific tracks by moving the head to precise distances from the center of the platter 112. FIG. 1 also shows platter 112 being radially divided into 8 sectors and concentrically divided into 5 tracks. The tracks and sectors may not be physical features, but rather areas of the platter's surface that are designated for data storage. As the platter rotates a full revolution, all 8 sectors of a single track may pass under the read/write head 115, allowing the head to read or write data along the path of the track. The head positioning mechanism may move to position the head over different tracks. By identifying a specific track and a specific sector, the combination of positioning the head and spinning the platter may allow data to be read or written at a specified track and sector. As an example, FIG. 1 shows the head 115 currently positioned over sector 7 track 2.

For simplicity and clarity of illustration, the example only shows 5 tracks and 8 sectors, but other embodiments may have any feasible number of tracks and sectors (e.g., hundreds of tracks, dozens of sectors, etc.). In some embodiments, the number of tracks and/or sectors may be specified by controller 120, which can then format the platter's surface accordingly by writing formatting data on the surface, and storing the formatting information in the controller.

In a conventional system, a defined amount of data may be written to a single sector on a single track, which may be chosen based on various factors, such as but not limited to which tracks/sectors do not already contain valid data and are therefore available for storage. The stored data may later be read from that same sector/track. A list of which data is stored at which sector/track may be maintained for the purposes of finding and retrieving the data from the disk drive. Although data may sometimes be stored redundantly for various purposes (e.g., for backup, as scratch pad data, for use/modification by different programs, etc.), the sector/track locations for this redundant data are generally chosen based on where storage space is available. There is no correlation in a conventional system between the physical locations where the original data is stored and where the redundant data is stored, and the different copies of the data are identified as separate datasets by application programs.

In various embodiments of the invention, however, duplicate data may be stored in multiple sectors of the same track for the purpose of improving read access times. For example, using the sectors/tracks of FIG. 1 as an example, data may be stored at sector 4 track 1, while identical data may be stored at sector 8 track 1, on the opposite side of the platter. The application programs that use this data may not be aware there are separate copies of the data, but simply request the data from a single known location. Once the data is requested, the disk controller may move the read head to the appropriate track, determine which sector of that track will pass under the read head first, and read the data from that sector, thus providing faster average data access time than a conventional system. Since the two copies are not considered separate datasets, if the data in one copy is modified, the data in the other copy must also be modified in the same way, so that they will still represent identical copies of the same data.

The previous example describes two copies of the data, but other embodiments may provide three, four, or more copies in different sectors. In some embodiments, the duplicate sectors may be equally spaced around the track. If the number of sectors in each track does not permit equal spacing, the nearest approximation to equal spacing may be used (for example, if there are 16 sectors per track and three duplicate sectors are being used, a spacing of 5, 5, and 6 sectors might be chosen). In another example, one of the two chosen sectors may be unavailable for writing because it already has valid data in it, but the adjacent sector may be available. In such a circumstance, some embodiments may choose the adjacent sector for writing. While the duplicate sectors will no longer be equally spaced, they may be close enough to equal spacing to still provide an advantage in average access times.

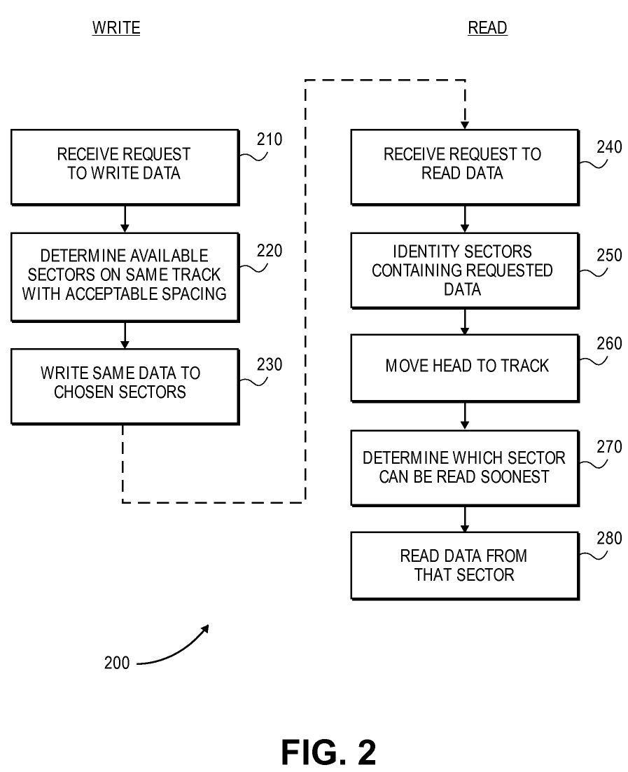

FIG. 2 shows a flow diagram of a method of reading and writing duplicate data in multiple sectors, according to an embodiment of the invention. In flow diagram 200, identical data may be written to multiple sectors in operations 210-230, while that data may be later read from one of those sectors in operations 240-280.

At 210, a request may be received by the disk controller to store data on the disk drive by writing a sector of that data onto the disk platter. At 220, multiple sectors may be found that are available for writing new data, and that are also spaced around the track with acceptable spacing (e.g., two sectors on opposite sides of the track). At 230, the same data may be written to each of those multiple sectors.

At a later time, when an application program wishes to read the stored data, a request to read the data may be received at 240. The two (or more) sectors containing duplicate copies of that data may be identified at 250, and the read head moved at 260 to the track containing those sectors. At 270, it may be determined which of those multiple sectors can be read the soonest (e.g., which sector will pass under the read head first). This information may be easy to determine, as many disk drives are able to identify which sector is currently under the read head, at least with a reasonable degree of accuracy. At 280, the data may be read from the sector that was identified at 270 as the first available.

In an alternative read process, after the sectors containing duplicate data have been identified, the disk controller may initiate a read operation from both sectors without trying to determine which will be available soonest. The first sector that is read will provide the data the soonest. The other sector may also be subsequently read, but that data may be ignored since it is no longer needed. In some embodiments the system may read from each of the duplicate sectors, and in the case of corrupted data in one sector, be able to detect and correct the error.

Although the descriptions herein generally describe reading and/or writing a single sector's worth of data, some data may be large enough to require multiple sectors of data storage. In such cases, contiguous sectors may be found to store data in each of the multiple locations on the track (for example, two sectors worth of data may be stored on a track in sectors 2 and 3, and a duplicate set of the data may be stored on the opposite side of the track in sectors 6 and 7).

Alternately, when the multiple related sectors are scattered, with connecting information to daisy chain them together (for example, the first sector of information may be written on track 2 in sectors 4 and 8, while the second sector of information may be written on track 3 in sectors 1 and 5), then each of the copies of the first sector may have information to link it to either of the copies of the second sector (using the same example, track 2 sector 4 would be linked to both sectors 1 and 5 of track 3, while track 2 sector 8 would also be linked to both sectors 1 and 5 of track 3.

In still another alternative, only one copy of each sector of information may be specified, and linked to the next sector in a conventional manner, but it may be assumed that every specified sector has a duplicate copy in the opposing sector of the same track (or with whatever uniform sector spacing is being used).

Although the foregoing text only describes a single side of a single disk platter, some embodiments may store data on both sides of the platter, and/or may have multiple platters, each with its own read/write head(s). The principles previously discussed may also be applied to each of those platters, sides, and read/write heads. In some embodiments, the sectors containing duplicate copies of the data may be located on different platters or sides. For example, one copy of the data may be located in sector 3 track 1 side 1 of platter 2, while the duplicate copy of the data may be located in sector 7 track 1 side 2 of platter 3. If the read heads for the different platters/sides are mounted such that they are all positioned over at the same time, the same general process may be used that was described for a single side of a single platter.

Besides the advantage of achieving faster average access time to read data, various other advantages may be obtained from the techniques described herein. For example, the spin rate of the disk platter may be slowed down, raising the average access time to what it would be in a conventional disk system, but with lower power consumption by the disk spin motor. Alternately, a combination of slower spin rate and faster access times may be obtained by trading off those two considerations.

The foregoing description is intended to be illustrative and not limiting. Variations will occur to those skill in the art. Those variations are intended to be included in the various embodiments of the invention, which are limited only by the spirit and scope of the following claims.

What is claimed is:

1. An apparatus, comprising
a disk drive controller configured to:
perform a write operation by writing identical data to each of multiple sectors on a same track of a disk drive; and
perform a read operation by reading the data from a one of the multiple sectors that is readable soonest.

2. The apparatus of claim 1, wherein the multiple sectors are approximately equally spaced around the track.

3. The apparatus of claim 1, wherein the multiple sectors consists of three sectors.

4. The apparatus of claim 1, wherein the multiple sectors consists of two sectors on opposite sides of the disk drive from each other.

5. The apparatus of claim 1, wherein said performing a read operation comprises:
determining which one of the multiple sectors will be readable soonest; and
reading the data from the one of the multiple sectors that is determined to be readable soonest.

6. The apparatus of claim 1, further comprising the disk drive coupled to the disk drive controller.

7. The apparatus of claim 1, wherein:
a spin rate of the disk drive is to be reduced;
an increase data latency caused by the reduced spin rate is to be at least partially offset by a decrease data latency caused by having the data available from the multiple sectors

8. A method, comprising:
receiving a request to write data to a disk drive;
determining multiple sectors on a same track that are available for writing to and that are approximately equally spaced around the track; and
writing the data to each of the multiple sectors.

9. The method of claim 8, further comprising:
receiving a request to read the data that was written to the disk drive;
reading the data from the one sector of the multiple sectors that is available to be read soonest.

10. The method of claim 9, wherein said reading the data comprises:
determining which of the multiple sectors will be available to be read soonest; and
performing a read operation from the sector that was determined to be available to be read soonest.

11. The method of claim 8, further comprising:
receiving a request to read the data that was written to the disk drive;
determining which sectors the data was written to;
specifying a read operation to all of the sectors that were written to; and
using the data from the sector that is read soonest.

12. An article comprising:
a tangible machine-readable medium that contains instructions, which when executed by one or more processors result in performing operations comprising:
receiving a request to write data to a disk drive;
determining multiple sectors on a same track of the disk drive that are available for writing to and that are approximately equally spaced around the track; and
writing the data to each of the multiple sectors.

13. An article comprising
a tangible machine-readable medium that contains instructions, which when executed by one or more processors result in performing operations comprising:
receiving a request to read data from a disk drive, wherein multiple copies of the data are stored on multiple sectors of a same track of the disk drive; and
reading the data from the disk drive.

14. The article of claim 13, further comprising operations of:
determining, prior to said reading the data from the disk drive, which sectors the data is stored in;
determining, prior to said reading the data from the disk drive, which particular sector of the of the sectors the data is stored in will be available to be read soonest; and
initiating a read operation to the particular sector

15. The article of claim 13, further comprising operations of:
determining, prior to said reading the data from the disk drive, at least one of the multiple sectors the data is stored in;
initiating a read operation to the at least one of the multiple sectors; and
receiving the data from a particular one of the multiple sectors that was readable soonest; and
using the data from the particular sector.
